(19) United States
(12) Patent Application Publication
(10) Pub. No.: US 2013/0345488 A1
(43) Pub. Date: Dec. 26, 2013

(54) ORGANIC NITRATE EXPLOSIVE TREATMENT SYSTEM

(71) Applicants: Dennis A. Brunsell, Knoxville, TN (US); Charles E. Jensen, Knoxville, TN (US); Larry E. Beets, Knoxville, TN (US)

(72) Inventors: Dennis A. Brunsell, Knoxville, TN (US); Charles E. Jensen, Knoxville, TN (US); Larry E. Beets, Knoxville, TN (US)

(73) Assignee: DIVERSIFIED TECHNOLOGIES SERVICES, INC., Knoxville, TN (US)

(21) Appl. No.: 14/003,795

(22) PCT Filed: Mar. 4, 2012
(86) PCT No.: PCT/US2012/027647

§ 371 Date: Sep. 7, 2013

Related U.S. Application Data
(60) Provisional application No. 61/450,609, filed on Mar. 8, 2011.

(51) Int. Cl. A62D 3/02

(52) U.S. Cl. CPC A62D 3/02; A62D 2101/06
USPC 588/403

(57) ABSTRACT

The present Treatment System (10) addresses destruction of general nitrogen based organic (plastic) explosives in wastewater discharge applications and potential recovery of quantities of explosives otherwise lost to the environment. The Invention (10) addresses the problem of such explosive matter entering the environment in one aspect of the invention by treating a wastestream or aqueous substance from a plant containing such matter by a process including selective filtration (16), reverse osmosis (18), crystallization (20) and continuous retained biological treatment (12) to recover a maximum amount of explosive material from the wastestream or aqueous substance, containing organic nitrate explosive matter and related materials prior to discharge to the environment, or for the purposes of recycle, burning or food for the continuously retained biological subsystem when utilized in the invention. In included aspects of the system (10) filtration sub-process 1 (S-p 1), crystallization and filtration sub-process 2 (S-p 2) and continuous biotreatment sub-process 3 (S-p 3) are employed to resolve the problem of excessive explosive materials being dumped as waste into the environment and the problems imposed in treating wastestreams and providing clean aqueous matter to the environment after treatment.

### BACKGROUND OF THE INVENTION

1. Field of the Invention

The present invention relates to a Method, Process or System for the destruction of general nitrogen based organic (plastic) explosives in wastewater discharge applications and potential recovery of quantities of explosives otherwise lost to the environment.

2. Background Information

In the past, the process of chemically producing nitrogen based plastic explosives has been an aqueous process using organic chemicals processed using nitric acid. The solubility of the explosives was normally in the range of 1-100 ppm, depending upon temperature in the resulting wastewater. The water was usually near saturation in these explosives as crystallization was the main recovery method. The explosive was then washed with hydroscopic solvent (i.e. acetone) for removal of remaining water. This resulted in contamination of these solvents in the wastewater. Current wastewater technology for these types of explosives has utilized more conventional municipal sewer type treatment systems. These systems have not been found suitable for removing complex nitrate molecules found in explosives. Some newer treatment systems have been developed for treatment of nitrates from fertilizers, but these, again, have been very poor converters for nitrates found in explosives. Also due to the high concentrations of nitrates, the size and retention time required for the high volume of waste (200-2000 m3/day) has made these systems enormous in both size and capital cost. Also, because of the batch nature of production the cost of maintaining these systems in viable activity during months of no explosive production has been significant.

Denitrifying bacteria used to destroy nitrates, nitrites and ammonia have been cultured over the years for the purpose of destroying fertilizers and other chemical discharges. These denitrifying bacteria have operated under anaerobic conditions where the oxygen for normal cell processes was replaced under anaerobic conditions through utilization of the oxygen from NO3- or NO2-, with the release of nitrogen as a gas. These reactions were often carried out in packed columns where the bacteria attached themselves to the packing and the wastewater trickled over the packing with the columns being excluded from air (oxygen). This process was found to work well where there was a continuous source of wastewater and nitrates. The production of DNAN, RDX and other plastic type explosives were done on a batch, as needed, basis such that a time break of anywhere from a few days or many months in production could occur. During this period the bacteria tended to die and/or go to a spore state. It could take many hours or even days for the colony growth to again regain its ability to fully treat a concentrated stream of the nitrate explosive wastewater. This resulted in limitations on production, large holding tanks or environmental releases, all of which proved not to be practical.

### SUMMARY OF THE INVENTION

The foregoing and other objects of the invention can be achieved with the present invention which provides for a novel process, method, system and accompanying equipment which includes selective filtration, reverse osmosis, crystallization and/or continuous retained biological treatment to recover a maximum amount of explosive material from a wastestream or aqueous substance, containing organic nitrate explosive matter and related materials; for discharge to the environment, recycle, burning or as food for continuously retained biological systems. The teachings of the present invention also relate to and address further concentration of the nitrogen based explosive (NX) using filtration, reverse osmosis and crystallization; and producing environmentally releasable water, either directly or through further biological treatment.

### BRIEF DESCRIPTION OF THE DRAWINGS

FIG. 1 is a schematic flow sheet diagram illustration of a preferred embodiment of the ORGANIC NITRATE EXPLOSIVE TREATMENT SYSTEM (ONETS) of the present invention.

FIG. 2 is a flow sheet diagram of another preferred embodiment of the present invention emphasizing illustration of the sub-systems of the ONETS invention including S-p 1, S-p 2 and S-p 3.

FIG. 3 is an illustration of a continuously retained biotreatment column in the form of a trickle down bioreactor, of a preferred embodiment of the present ONETS invention.

FIG. 4 is a flow sheet diagram of the embodiment of FIG. 1 emphasizing illustration of the sub-systems of the present invention including S-p 1, S-p 2 and S-p 3.

FIG. 5 is a flow sheet diagram illustration of a simplified or basic embodiment including a pump and RO unit for achieving the functional aspects of the present ONETS invention.

FIG. 6 is a flow sheet diagram illustration of a further simplified or basic embodiment for carrying out the functional aspects of the invention.

FIG. 7 is a flow sheet diagram of another preferred embodiment of the present invention including a double pass RO unit.

FIG. 8 is another preferred embodiment of the continuously retained biotreatment column of FIG. 3 of the present invention where the influent enters from the bottom of the column to be treated as it is in the present invention while moving to the top of the column where effluent and nitrogen gas (N₂) exit.

FIG. 9 is a flow diagram illustration of another preferred embodiment of the present ONETS invention employing a double pass RO unit.

### DETAILED DESCRIPTION OF THE INVENTION

The following description of the preferred embodiments of the concepts and teachings of the present invention is made in reference to the accompanying drawing figures which constitute illustrated examples of the teachings and elements of the invention; among many other examples existing within the scope and spirit of the present invention.

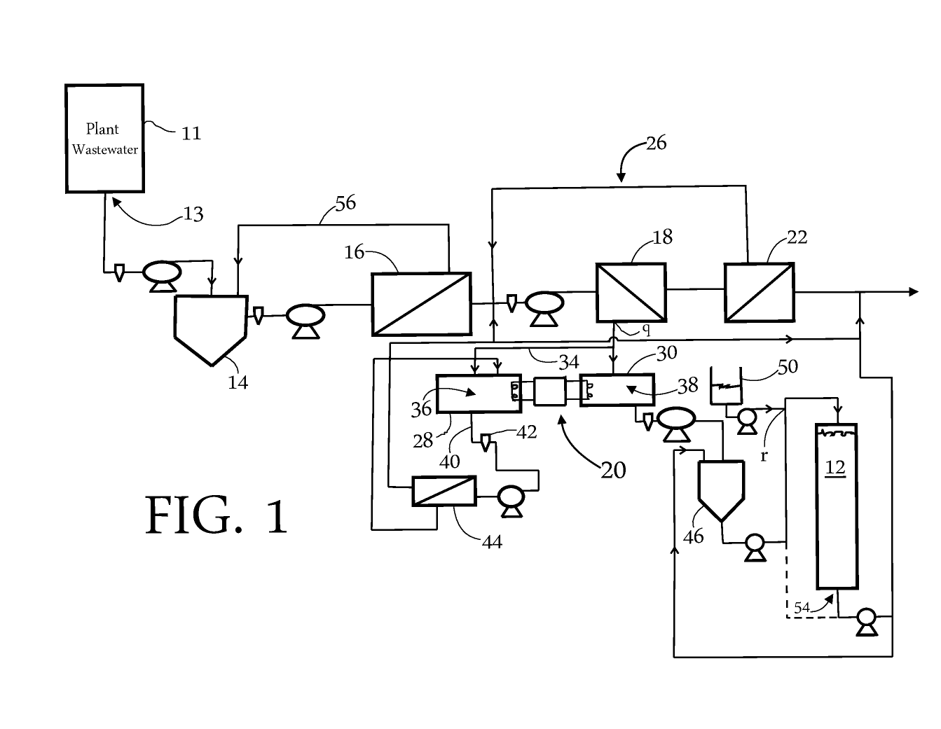

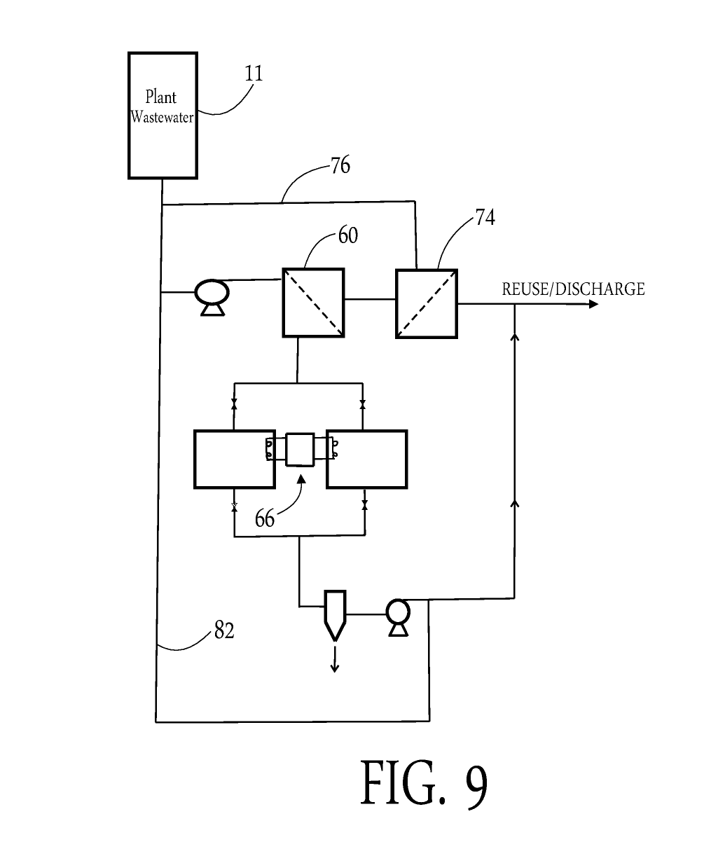

Referring now to the drawings, FIGS. 1 through 9, thereof, there is illustrated by schematic flow sheet diagrams and other illustrations, exemplary embodiments of the present invention addressing the Organic Nitrate Explosive Treatment System, at 10; and referred to hereafter as the ONETS, the system, the Method, the process, or the invention 10. It will be understood that a diverse number and type, without limitation, of structural lines, transfer means and valves, and different but functional arrays thereof, can be utilized to bring about and affect the desired directional flow and communication of identified substances or respective fluid amounts discussed in the present disclosure and illustrated by flow arrows (->and <-), lines and valves in the schematic drawing illustrations.

As indicated, the ONETS 10 is applied to recover as much of the explosive as possible for recycle burning and food for biological systems. It has been found in this regard that each nitrogen based explosive (referred to herein as NX) has slightly different properties so that the ONETS 10 is flexible and adaptable through combination of its treatment elements to optimize for recovery of NX.

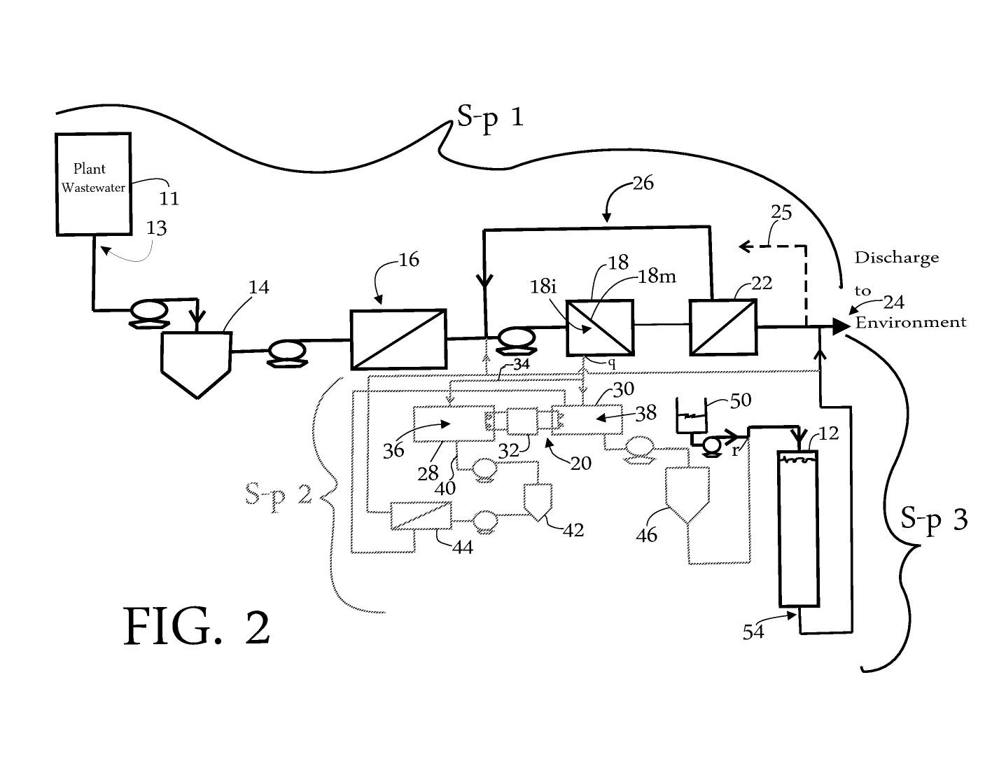

In one preferred embodiment of the invention 10, illustrated in FIG. 2, the continuous retained biotreatment element or biotreatment element 12, is utilized for treating aqueous substances having organic nitrate explosive matter for discharge to the environment or for recycle with the system 10. This embodiment of the system 10 includes communicating a volume of plant feed 13 from the plant wastewater tank or area 11 to the steam generation or cross-flow membrane recycle area 14; and from the steam area 14 to the cross-flow membrane area 16 for filtering the plant feed to about 0.05 micron and removing at least part of its suspended solids, oils and greases, metal complexes and colloidal material in this volume.

This embodiment further includes treating the plant feed by the first (11 reverse osmosis or RO means 18. This results in a reject fluid portion 15 of the volume of plant feed 13 communicated from a point or area q close to but beyond or outside of the inflow side of the RO 18, as illustrated by example in FIGS. 1 and 2; to the chilling crystallization means, unit or units 20 of the system's (10) sub-process S-p 2. This further results in communicating or sending the permeate portion 17 of the plant feed 13 coming through the media 18m to the second reverse osmosis or RO means 22. The permeate portion 19 passing through the media 22m of the second RO means 22 can preferably be discharged at the environmental release point 24 to the ambient environment; or the permeate portion 19 can be recycled to the plant for reuse 25.

Additionally, a small amount, volume, or sub-reject portion of the permeate portion 17 entering the second RO 22 but not passing through its media 22m can be recycled and communicated 26 to an area in front of, or upstream from, the first RO 18. In this preferred embodiment, illustrated by example in FIG. 2, this constitutes the S-p 1 sub-process of the system 10.

As a part of the S-p 2 sub-process of the system 10, the chilling crystallization means 20 utilizes one or more reject tanks, shown by example in FIGS. 1, 2, 4, 7 and 9. For example, as shown in FIG. 2, the first reject tank 28 and the second reject tank 30 are operably connected and functionally linked to the chiller subassembly 32. As they are so connected, each of the reject tanks, 28 and 30, is chilled to a low enough temperature such that crystallization and precipitation materials form from at least part, if not substantially all, of the contents within each tank 28 and 30. Each of the tanks is further provided with mechanical and functional means or equipment for timely evacuation of the crystallization and precipitation materials from each respective tank. Therefore, as discussed in other places herein, the chilling crystallization means 20 serves in this embodiment as the location where the reject fluid portion 15 precipitates the excess NX to a solid (crystalline) form. This solid is separated so the remaining solution is only saturated with the NX.

In this regard, within this embodiment, a first sub-portion of the reject fluid 15 is communicated, channeled or transferred 34 to the first reject tank (28). This forms the first residence fluid 36 in the first tank 28. A second sub-portion of the reject fluid 15 is communicated, channeled or transferred to the second reject tank 30, to form the second residence fluid 38 in the second tank (30). During specified or selected periods of time, or x and y-periods of time, as this pertains to residence time within the first tank 28 and the second tank 30, within this embodiment, sub-steps are carried out regarding the fluids 36 and 38 in the respective tanks 28 and 30. These sub-steps include communicating, channeling or transmitting 40 a portion of the first residence fluid (36) from the first reject tank 28 to the bag filter means 42. The first residence fluid 36 is then transferred or communicated from the bag filter 42 to the HPRO filter 44. In the process of encountering or passing through the media of the HPRO 44 the reject first residence fluid and the permeate first residence fluid are formed. The bag filter utilized as the bag filter 42 is a preferred filter means but other forms of filtration or solid-liquid separation can be used such as Hydrocyclone and other means. The permeate first residence fluid is recycled to point q and the reject first residence fluid is communicated or transferred to the second reject tank 30. The biotreatment liquid is formed within the process of this embodiment in the reject tanks 28 and 30. In this and related embodiments two, three or more such reject tanks, such as tanks 28 and 30, are not always needed in a particular system and will not be employed.

These sub-steps continue with the biotreatment liquid so formed in the second reject tank 30. Accordingly, the biotreatment liquid is passed through the bag filter 46, and from the filter 46 to point r. Point r is a point or regional location outside the continuous retained biotreatment element (12) while also be served by and connected to the nutrient means (50). It marks one of the outside limitations of the S-p 2 sub-process of the invention in this embodiment, as illustrated in FIG. 2. It also marks the point where it is connected to the nutrient means 50 where the S-p 3 sub-process of this embodiment begins.

Accordingly, the biotreatment liquid passes or is communicated from point r to the continuous retained biotreatment element or biotreatment element 12, where the biotransformed liquid is generated or made.

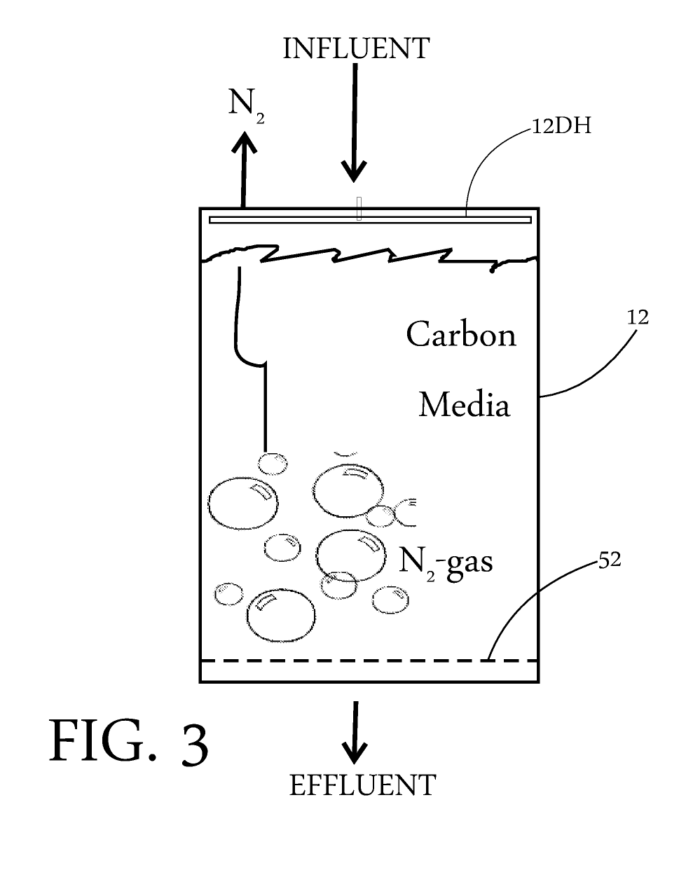

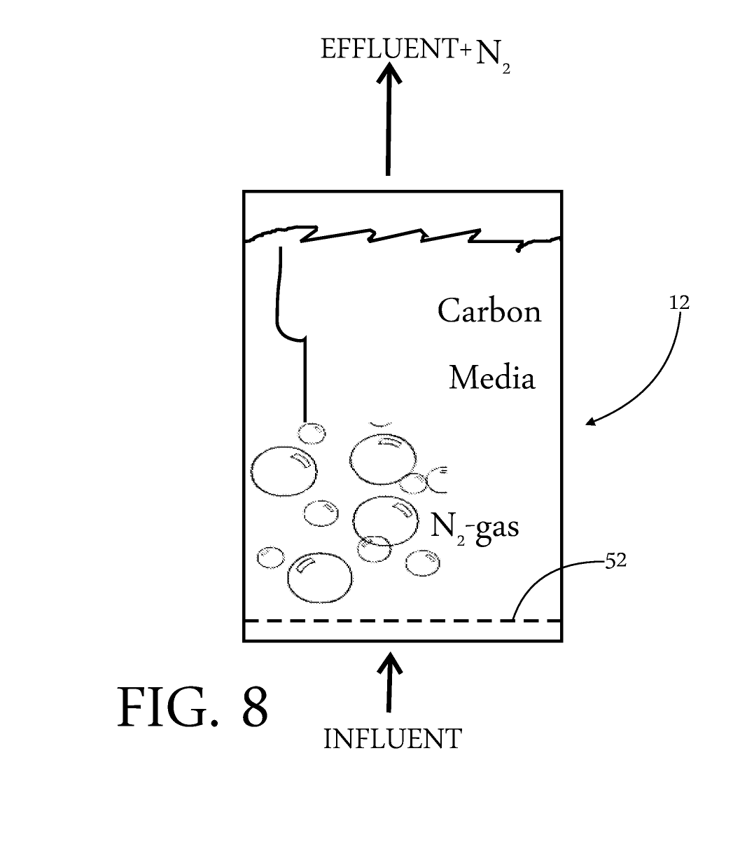

The biotreatment element 12 is, preferably, a carbon-media-microbioorganism column producing nitrogen gas distribution and having retention means 52, shown by example in FIGS. 3 and 8. The biotreatment element 12 is actively maintained continuously for use as needed in distinction with biological prior art means. In assisting this aspect of the invention's embodiment the biotreatment element 12 is supplied by the nutrient means 50 which is functionally connected, as illustrated by example in FIG. 2, to point r for nutrient supply to the biotreatment element 12 as needed for continuous around the clock functional availability of nutrient substances to the element 12.

The final regular step of this embodiment is transfer, transmission or communication 54 of the biotransformed liquid in and from the biotreatment element 12 to the environmental release point 24 for discharge at this location. Communication from point r, as indicated, to the release point 24 constitutes the S-p 3 sub-process of this embodiment of the invention 10.

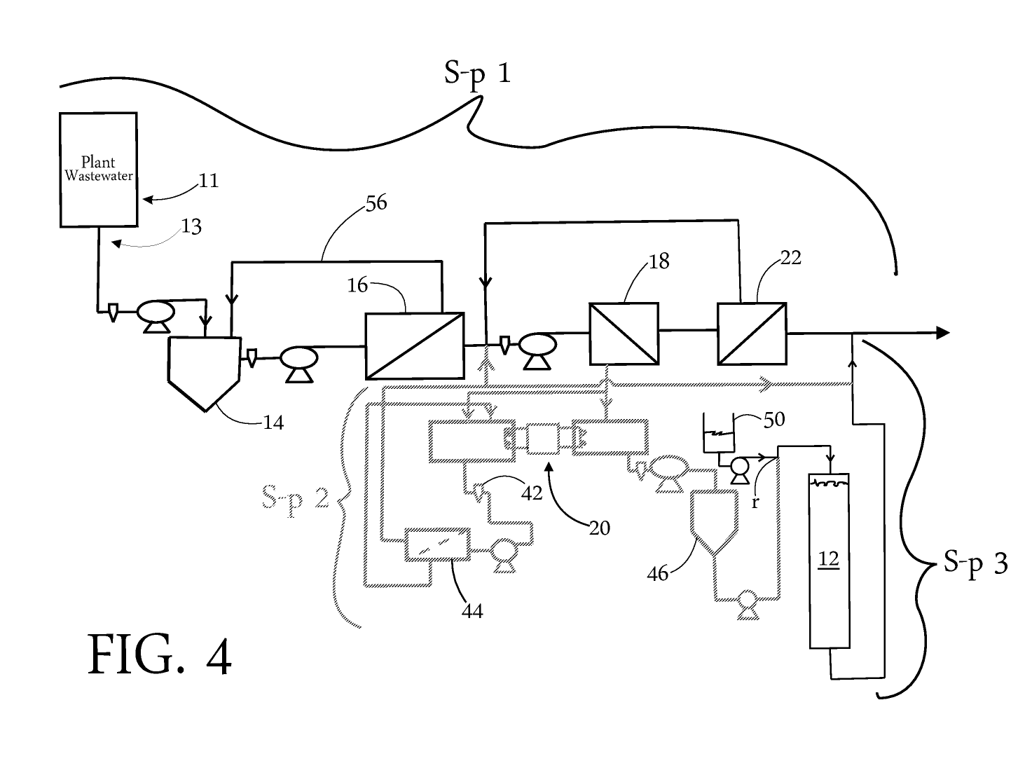

In a related embodiment of the present system 10, illustrated by example in FIGS. 1, 3, 4 and 8; the S-p 1 sub-process of the system 10 is substantially similar to the embodiment already described in relation to FIG. 2. FIGS. 1 and 4 illustrate by example as a part of the S-p 1 sub-process, as described above, that a volume of plant feed 13 from the plant wastewater tank or area 11 is communicated to the steam generation or cross-flow membrane recycle area 14; and from the steam area 14 to the cross-flow membrane area 16 for filtering the plant feed to about 0.05 micron and removing at least part of its suspended solids, oils and greases, metal complexes and colloidal material in this volume. However, in the embodiments of FIGS. 1 and 4 a portion of or all of substances not passing through the cross-flow membrane area 16 are communicated and recycled back to the steam generation or cross-flow membrane recycle area 14 for further processing.

Also set forth with regard to the preferred embodiment of FIGS. 1 and 4, are portions of the S-p 2 sub-process thereof. In this regard, in a similar manner to that of the embodiment of FIG. 2, involves the step or sub-step 40 of essentially communicating, channeling or transmitting a portion of the first residence fluid (36) from the first reject tank 28 to the bag filter means (42) and from the bag filter 42 to the HPRO (high pressure reverse osmosis) filter 44.

The invention, therefore, employs several aspects within its teachings; including filtration, reverse osmosis, crystallization and/or biological treatment; to remove the discharge of treated waste water to below environment discharge limits regarding explosive substances.

These invention aspects are applied to recover as much of the explosive content that is possible for recycle, burning and as food for biological systems. The invention 10 is also adapted structurally and functionally to address the flexibility that is often necessary at many waste sites, in that each nitrogen based explosive (NX) has slightly different properties so that the combination of treatment strategies must often be varied to optimize the invention's process for recovery of NX. The teachings of the invention, therefore, address further concentration of the nitrogen based explosive (NX) utilizing filtration, reverse osmosis and crystallization, and producing environmental releasable water either directly or through further biological treatment.

Filtration is essential in the process 10, but due to the possible detonation of the explosive material being treated by friction and compression, a mechanism must be considered in protecting various equipment, when no protection would be required if applied in non-NX applications. This means that crystalline NX must be removed prior to any pump or similar device with close tolerances to prevent any possible pinch point detonation. Therefore, bag filters are typically positioned prior to pumping devices employed in the invention system 10 to remove particulate of 5 microns or larger.

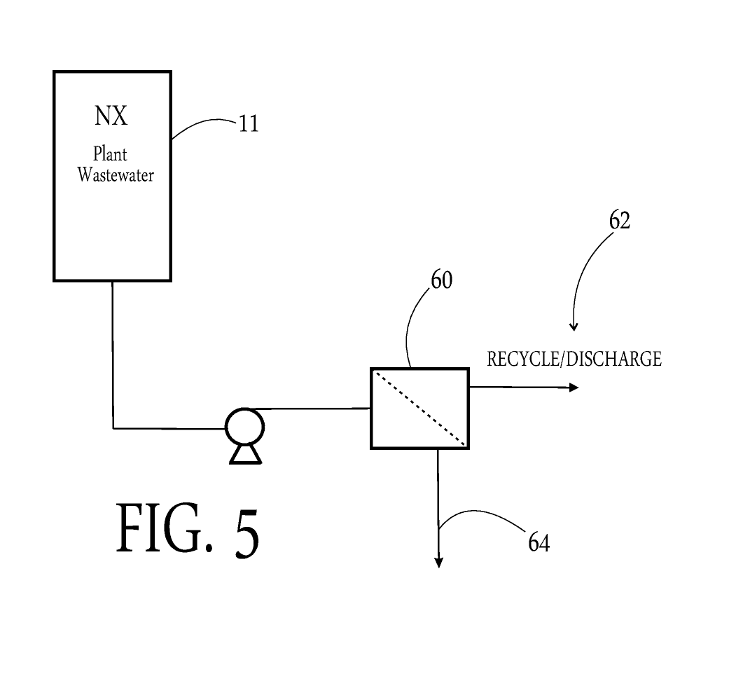

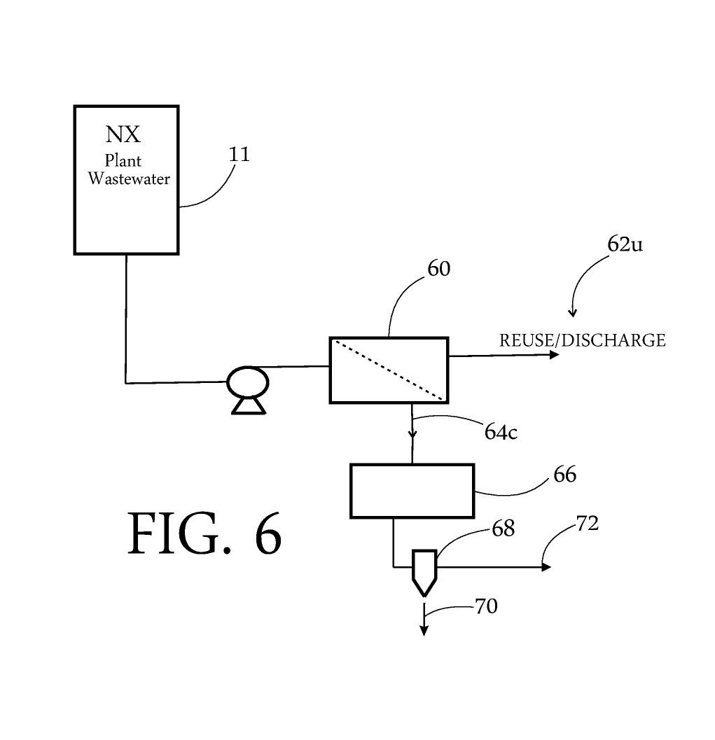

More basic, but functional teachings within the scope and spirit of the present system 10 are set forth by example in FIG. 5, 6 or 7. FIG. 5 illustrates only a preferred invention embodiment where only the reverse osmosis (RO) 60 is principally used to bring about the invention's functional NX-removal-result. In this embodiment the permeate volume of treated wastewater (11) passing through RO 60 is recycled or discharged 62. While the reject volume of wastewater not passing through the RO 60 is sent for tertiary treatment or discharge 64. FIG. 6 illustrates, in this regard, the RO 60, permeate volume of treated waste water passing through RO (60) reused or discharged 62u, the reject volume of the wastewater not passing through the RO (60) being communicated or transferred 64c to the crystallizer 66, and then to the solid-liquid separation means, device or unit 68. This then proceeds to NX recovery or waste 70, or to discharge or other use 72, illustrated schematically in FIG. 6.

In this regard, the reverse osmosis separates the stream into the permeate stream that is much lower in NX concentration and the concentrate stream that has a smaller volume but higher concentration of NX. This concentrate stream is supersaturated in NX. This supersaturated stream is directed to the crystallizer 66 where the stream precipitates the excess NX to a solid (crystalline) form. This solid can be separated by the solid/liquid separation means 68 so the remaining solution is only saturated with the NX. This stream can either be recombined with the permeate, recycled to the beginning of the treatment process 82 or sent for other processing that may include a biological treatment process described earlier in the preferred embodiment in relation to FIGS. 1, 2, 3, 4 and 8. The process of the RO/Crystallization/Solid/Liquid Separation may reduce the NX by a factor of 10. If this reduction is not sufficient then further processing using recycle and a second pass reverse osmosis unit may be required.

In a further preferred embodiment of the system 10 the use of Hydrocyclones is employed to remove particulate NX to be collected for recycle back to the NX process where washing and dewatering steps prepare the NX for final use. The Hydrocyclone deposits the solids into a container for both further dewatering and transport, or for direct slurry transport to the NX process.

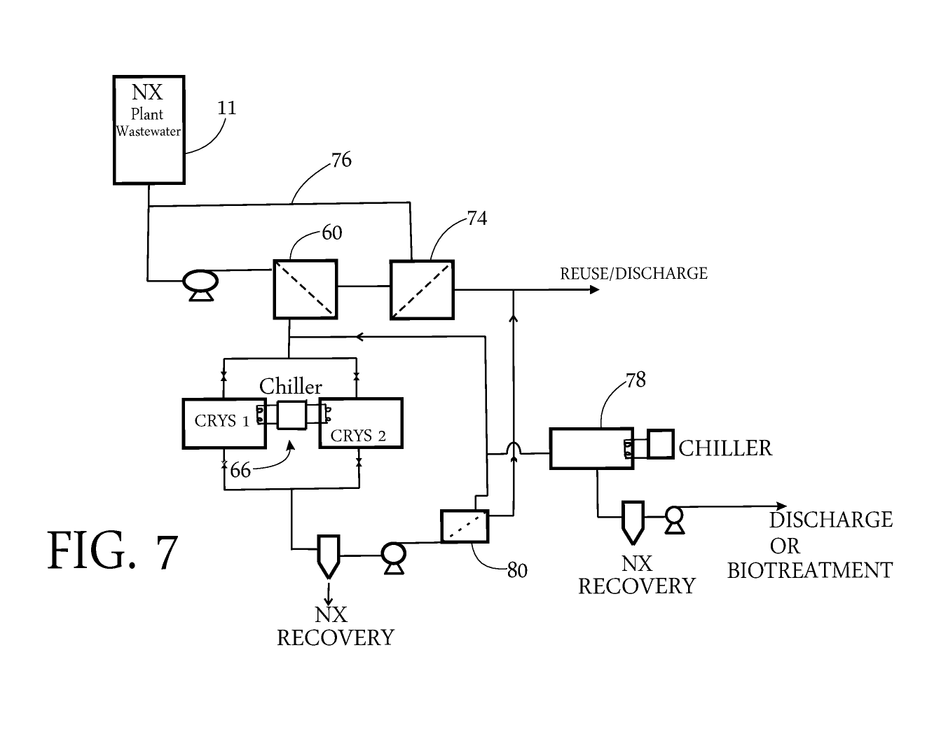

As indicated above, if a second pass reverse osmosis unit is required, the 2^{nd} Pass RO 74, illustrated by example in FIG. 7, will further reduce the NX concentration so that direct discharge to the environment is possible. The reject of the second pass 74 is either recycled 76 to the feed of the 1st Pass RO (60) or sent to the crystallizer 66 depending upon the NX concentration.

As a further preferred embodiment, the wastewater is then passed through ultrafiltration to remove any particulate down to 0.05 microns to prevent possible fouling of the reverse osmosis (RO) membranes 60 and 74 from insoluble particulate. It has been found that downstream RO membranes have many tortuous paths that can retain particulate causing excessive pressure drops. These pressure drops can ultimately result in the premature replacement of the membranes that are both costly to replace and which require incineration for disposal due to contamination with NX. The optimum filter utilizes tubular ultrafilter membranes with cross-flow filtration, with long life membranes, so that minimal secondary waste is generated.

The feed water in to the ultrafilter can be heated slightly to increase solubility of the NX, thus preventing any precipitation in the ultrafilter. Either direct injection of steam or a heat exchanger deployment can be utilized. The steam or heat exchanger is also utilized to heat either NX free process water or RO permeate for cleaning of the ultrafilter and RO membranes. The heated and low concentration of NX provides for re-dissolution of NX that has been rejected by the membranes. After use, this cleaning water can be recycled to the system feed tanks for subsequent processing.

The filtrate from the ultrafilter is sent through reverse osmosis for concentrating the NX in solution. The NX can be supersaturated for a short period of time while in the membranes, to permit this concentration process. The RO concentrate from the 1st Pass RO 60 is sent to a concentrate tank. This solution is either chilled prior to entry or after entry into the tank or crystallizer 78. The cooling decreases the solubility of the NX causing precipitation/crystallization to occur. The optimum temperature is near the freezing point of water, where many NXs have a solubility that approaches 0 ppm.

The crystallizer, 66 or 78 can take many forms in their application within the scope of the system 10, with some being as simple as a tank which has the ability of solids removal. In a preferred embodiment, the crystallizer efficiency is supplemented through the use of a heat exchanger to cool concentrate thus reducing the solubility of the NX. This effectively removes a larger percentage of the NX from the concentrate. The concentrate can then either be combined with the permeate for reuse or discharge, or recycled to the front of the system for further concentration, thus producing more low NX concentration permeate and a further reduced volume of concentrate. This can be repeated until the osmotic pressure of the other soluble salts increases beyond the osmotic pressure capability of the RO.

The concentrate tank solution; after cooling, if desired, and time period required for crystallization to approach completion; is drained through a filter solid/liquid separation device to collect the NX solids. The filtrate solids free liquid is then either reused, returned to the 1st Pass RO 60 feed for further processing, bio-treatment system or to a higher pressure RO based on the concentration of other salts increasing the osmotic pressure of the RO to a level requiring higher feed pressure.

In another preferred embodiment of the invention 10, concentrate from the concentrate tanks (crystallizers) can be directed to the Higher Pressure Reverse Osmosis means or unit (HPRO) 80 which operates under the same concept as RO, except that the feed pressure is much higher to overcome the osmotic pressure. Because of the higher osmotic pressure and volume to be processed, the required volume of throughput is much lower. The HPRO 80 is utilized when the osmotic pressure is too high for further processing by the RO, or where supplemental processing of the 1st Pass RO concentrate is desired.

The HPRO 80 can take feed from any Concentrate Tank; and then reject of the HPRO is either returned to a separate HP Concentrate Tank or the same tank. The HP Concentrate Tank solution is processed a final time. After cooling and crystallization is complete, the concentrate volume typically represents less than 0.1% of the original feed volume. This concentrate is sent for discharge as the salts must be removed from the system. Although this concentrate has some remaining NX, the concentration is very low and does not cause a significant increase in the NX concentration in the final environmental discharge.

When environmental discharges are more limited or the NX too soluble for release by crystallization alone, a tertiary treatment of the reject, shown by schematic illustration in the drawings, and FIGS. 3 and 8, may be required and can be utilized. This treatment utilizes the use of anaerobic bacteria to destroy the nitrate groups releasing nitrogen to the environment. This process utilizes the oxygen contained in the nitrates as an oxidation source, but must have an organic source for the energy source required for the metabolism of the bacteria under such circumstances. In order for the columns to function aerobically, atmospheric oxygen must be excluded from the columns; otherwise the aerobic metabolism will dominate the process. During the conversion from aerobic to anaerobic all the oxygen present in the column must be utilized before nitrate reduction can occur; and is encompassed within the aspects and scope of the invention 10.

If nutrients are not present in the wastewater this organic source in the system 10 are nutrients added to the water prior to entering the bio-treatment column 12. This nutrient source is also important in maintaining a viable colony when the nitrogen source is removed and the system converts to an aerobic condition.

Although this process has been proposed by others for the treatment of nitrates, the batch nature and form of the nitrates causes difficulties in a standard anaerobic process. The NX process is batch based; that is the products are produced only periodically with anywhere from days, weeks and months between production runs. This establishes conditions where viable bacterial cultures are required to be maintained between production runs.

When using standard biological columns or pools, a down period of weeks or months would cause the bacteria to go dormant (i.e., convert to spore form). Recovery from this form usually takes many hours to days, depending upon temperature and nutrient feed conditions. Even if the bacteria is not dormant but has converted to the aerobic digestion, the conversion to anaerobic metabolism is not instantaneous. This would mean that the NX would be passed to the environment, or would have to be stored in tanks and recycled until the activity returned.

In a preferred embodiment of the process 10, carbon is substituted for more conventional support media. Through the use of a carbon substrate to anchor the bacteria, the carbon can be used as an absorbent for the NX until the bacteria returns to the anaerobic metabolism. On the back side of processing in this carbon use, the bacteria can remove the NX from the carbon to maintain at least a reduced anaerobic metabolism for an extended period after feed flow to the columns is terminated.

This aspect of the invention 10 eliminates or minimizes these problems through the utilization of a carbon based substrate rather than packing material normally made from either plastic or ceramic saddles or other such shapes. The carbon provides the required support media for the bacteria to attach, but also provides an adsorption of the NX to buffer the process. The carbon absorbs nitrate explosive during the early stages of production thus permitting the denitrifying bacteria to multiply to sufficient levels to effectively remove the entire nitrogen explosive from the waste stream. This capacity permits several hours of operation while the bacteria are either converting from spore form to active growing cells; and multiply as needed.

When the wastewater feed is suspended the bacteria are able to continue to feed from the picric acid absorbed on the carbon this maintaining a viable colony for a much longer period. The carbon also retains moisture longer than other packing materials thus preventing the formation of spores that must be reactivated.

The biological column 12 can be either a trickle down column shown by example in FIG. 3 which will permit nitrogen gas escape up through the bed; and which, together with Carbon media elements and other aspects discussed relating to these columns, is provided with the Distribution Header. The column 12 is also utilized in the present system 10 as an up flow column, shown by example in FIG. 8, also permitting venting of the nitrogen gas formed in the denitrifying process.

When the process is converted to aerobic condition, oxygen must be supplied either through aeration of the wastewater prior to entering the column or where air is injected to the bottom of the column and permitted to percolate to the top.

The process requires a nutritive source for the bacteria to grow. In most wastewater applications this source is from other components in the wastewater. In the case of the present process 10 a limited amount of nutrients are present or almost no nutrients are present, thus sugars or carbohydrates must be added to complete the digestion process. When organic chemicals such as acetone are present the bacteria can utilize these substances as the energy source, thus eliminating another waste product. The process can be continued when the nitrate explosives are not present by simply changing the system from anaerobic to aerobic by adding oxygenated water or bubbling air through the column as the oxygen source, because the bacteria, as utilized, can function in either mode. Therefore, a viable colony can be maintained indefinitely between production runs-an object and advantage of the present invention 10.

In a further preferred embodiment of the method 10 it utilizes some of the stored waste NX, either retained in the bio-treatment feed tank or other source that was stored from a previous production run; to be utilized to reconvert the aerobic column to anaerobic metabolism prior to feeding NX wastewater through the column. This can be started several hours before a production run so that the column can be prepared to immediately treat the wastewater to remove NX to near 0 ppm. Without this novel feature of the present invention the wastewater from the bio-treatment column 12 might have to be recycled for several hours until the bacteria became functional in the anaerobic metabolism.

Aspects of the overall process 10 will include membrane technologies to reduce the volume of the waste stream to a few percent of the initial flow rate. This allows the bio-treatment system to be a reasonable size since the wastewater stream may be 100-500 gpm.

In the case of one NX this process reduced the color of the water to acceptable levels even though the NX concentration would have met the discharge criteria except that the water was out of specification due to color.

### OTHER EMBODIMENTS

It should be understood for example within the scope of the present invention that the biotreatment teachings herein do not have to be utilized in all included embodiments of the present invention. For example, the present method could only comprise a filter means, 1 (or sole) Pass RO and a tertiary treatment as well as further embodiments comprising additional RO, TUF, bag filters, hydrocyclone subsystem or means, crystallizer and biotreatment; and such other useful embodiments within the full scope of the invention.

Another example of the present invention would only utilize a single pass case where either other tertiary treatment is being used or feed concentrations are lower and do not require a second pass.

Yet a further example of an additional embodiment of the invention would include operating the present method and system with only one reject tank (28).

Yet a further example of another included embodiment within the invention would include use, as indicated above and in the drawings of a Bag filter as a preferred filter means; but would also include other acceptable forms of filtration or solid-liquid separation such as a Hydrocyclone and/or other functionally related or equivalent sub-systems within the invention.

It should also be understood that further examples, in regard to the reject tank (28, 30, etc.) comprising or consisting of 2nd, 3rd and further such tanks can be utilized in preferred embodiments of the invention; but that in work or job-specified cases that the use of more than one such reject tank is not always needed or cannot always be justified in all applications of the invention.

It will thus be seen that the objects set forth above, including those made apparent from the proceeding description, are efficiently attained; and, since certain changes may be made in carrying out the above method and in construction of suitable apparatus in which to practice the method and in which to produce the desired product or results as set forth herein, it is to be understood that the invention may be embodied in other specific forms without departing from the spirit or essential characteristics thereof. For example, while we have simultaneously set forth an exemplary process/method and system where a continuously retained biological sub-system can be utilized as the principal means of extracting organic nitrate explosive matter and related materials, other embodiments not utilizing such biotreatment are also feasible, only part of which have been discussed herein by example, to attain the result of the principles of the method and system disclosed herein. Therefore, it will be understood that the foregoing description of representative embodiments of the invention have been presented only for purposes of illustration and for providing an understanding of the invention, and it is not intended to be exhaustive or restrictive, or to limit the invention to the precise forms disclosed. On the contrary, the intention is to cover all modifications, equivalents, and alternatives falling within the spirit and scope of the invention as expressed in the appended claims and those submitted thereafter in this case within the subject matter of the description herein.

Therefore, the scope of the invention, as indicated in the claims presented in the filing progression of this case will be intended to include variations from the embodiments provided which are nevertheless described by the broad meaning and range properly afforded to the language of the claims in the prosecution or patenting process, or to the equivalents thereof.

Thus, it is to be understood that while the present invention has been described in conjunction with the instant detailed description thereof, the foregoing description is intended to illustrate and not limit the scope of the invention, which is defined by the scope of the appended claims.

### DESCRIPTION OF REFERENCE NUMBERS, SYMBOLS AND ABBREVIATIONS

### ONETS Organic Nitrate Explosive Treatment System

10 Organic Nitrate Explosive Treatment System also referred to as the ONETS, the system, the Method, the process, or the invention

11 plant wastewater tank or NX plant wastewater tank area, or plant continuous retained biotreatment element, biotreatment column or element, biological column or bioreactor

12DH distribution header of biotreatment column (12) (FIG. 3)

13 volume of plant feed from plant wastewater (11)

14 steam generation or cross-flow membrane recycle area

15 reject fluid portion of the plant feed volume (13) in relation to the media 18m of the RO (18)

16 cross-flow membrane area

18 first (1st) reverse osmosis or RO means, or RO

18m RO media of RO (18)

18i inflow side of the media (18m) of the RO (18)

q point or area close to but beyond or outside of the inflow side (18i) of the RO 18

20 chilling crystallization means, unit or units of Sub-process 2 (S-p 2) of the system (10) (FIG. 2)

17 permeate portion of the plant feed volume (13) in relation to the media 18m of the RO (18)

22 second (2nd) reverse osmosis or RO means, or RO

22m filter media of the second RO means (22)

19 permeate portion fro

24 environmental release point to the ambient environment

25 recycle of permeate portion (17) to the plant (11) for reuse

26 recycling and communicating to an area in front of the first RO (18)

S-p 1 sub-process one (1) of preferred embodiments of the present invention including the biotreatment element (48)

28 first reject tank of the chilling crystallization system (20)

30 second reject tank of the chilling crystallization system (20)

32 chiller subassembly of the chilling crystallization system (20)

34 first sub-portion of reject fluid (15) communicated, channeled or transferred to the first reject tank (28)

36 first residence fluid in the first tank (28)

38 second residence fluid in the second tank (30)

40 communicating, channeling or transmitting a portion of the first residence fluid (36) from the first reject tank 28 to the bag filter means (42)

42 bag filter means

44 HPRO (high pressure reverse osmosis) filter

46 bag filter

S-p 2 sub-process two (2) of preferred embodiments of the present invention including the biotreatment element (48)

r a point or regional location outside the continuous retained biotreatment element (48) while also be served by and connected to the nutrient means (50)

50 nutrient means

52 retention means or media retainer (FIGS. 3 & 8)

54 transfer, transmission or communication of the biotransformed liquid in and from the biotreatment element (48) to the environmental release point (24)

S-p 3 sub-process three (3) of preferred embodiments of the present invention including the biotreatment element (48)

56 substances not passing through the cross-flow membrane area (16) communicated and recycled back to the steam generation or cross-flow membrane recycle area (14)

60 reverse osmosis unit (RO) (FIGS. 5, 6)

62 permeate volume of treated waste water passing through RO (60) is recycled or discharged

64 reject volume of wastewater not passing through the RO 60 sent for tertiary treatment or discharge

62u permeate volume of treated waste water passing through RO (60) is reused or discharged

64c the reject volume of the wastewater not passing through the RO (60) being communicated or transferred to the crystallizer 66

66 crystallizer

68 solid-liquid separation means, device or unit

70 NX recovery or waste

72 discharge or other use

74 2nd Pass RO

76 recycled to the feed of the 1st Pass RO (60)

78 crystallizer

80 Higher Pressure Reverse Osmosis means or unit (HPRO)

82 recycled to the beginning of the treatment process

### REFERENCES

The following references, to the extent that are considered to have any relevance, to the present invention or provide historical, background, or other details or edification supplementary to those set forth herein, are specifically incorporated herein by reference and as an aide to examining officials; and include the following:

U.S. Pat. No. 5,538,641

U.S. Pat. No. 5,403,490

U.S. Pat. No. 6,811,702

U.S. Pat. No. 5,062,957

U.S. Pat. No. 4,671,879

U.S. Pat. No. 4,209,390

U.S. Pat. No. 4,043,936

U.S. Pat. No. 6,551,511

U.S. Pat. No. 4,407,717

U.S. Pat. No. 4,431,543

U.S. Pat. No. 3,930,998

U.S. Pat. No. 3,939,070

U.S. Pat. No. 3,994,802

U.S. Pat. No. 4,056,465

U.S. Pat. No. 4,207,183

U.S. Pat. No. 4,407,717

U.S. Pat. No. 5,393,427

U.S. Pat. No. 7,550,087

U.S. Pat. App. Pub. No. 2008/0264858

U.S. Pat. App. Pub. No. 2010/0213134

U.S. Pat. App. Pub. No. 2005/0145563

German Patent Pub. No. DE3505651

1. A method for treating aqueous substances or a plant feed volume having organic nitrate explosive matter or NX therewithin, for safe discharge to the environment or recycle activities, said method comprising:
(a) removing at least part of suspended solids, oils and greases, metal complexes and colloidal material in the plant feed volume;
then
(b) treating the plant feed volume by at least a first means for reverse osmosis or RO, such that a reject fluid portion is formed which is supersaturated in NX, and sending the at reject fluid portion of the plant feed volume, from a point q proximate but beyond the inflow side of the at least first means for RO to a chilling crystallization system;
said chilling crystallization system having at least a first reject tank functionally linked to a chiller subassembly such that the at least first reject tank in being chilled to a lower temperature, which is near but above the freezing point of water, where NX has a solubility approaching 0 ppm, thereby causes crystallization and precipitation NX materials to form within each such reject tank, said at least first reject tank having means for timely evacuation of the crystallization and precipitation NX materials;
(c) communicating at least a first sub-portion of the reject fluid to said at least first reject tank to form at least a first residence fluid, and during at least an x period of time as to residence of the at least first residence fluid within the at least first reject tank carrying out at least the following sub-step:
transmitting a portion of the at least first residence fluid from the at least first reject tank to a means for filtration and solid-liquid separation and from the means for filtration and solid-liquid separation to a means for providing HPRO filtration to form a reject first residence fluid and a permeate first residence fluid, the permeate first residence fluid being recycled to said point q, and the reject first residence fluid being communicated back to the at least first reject tank, thereby forming a biotreatment liquid therewithin; and passing the biotreatment liquid through at least one means of filtration; and from said at least one means of filtration to a point r, and from the point r to at least one of a group of locations consisting of (1) an environmental release point for discharge and (2) a continuous retained biotreatment element for the production of a biotransformed liquid for discharge, the biotransformed liquid having further amounts of NX therein, when the biotreatment liquid still has NX substances therein.

2. The method of claim 1, wherein:
in step (b) in treating the plant feed volume by the at least first means for RO a permeate portion of the plant feed volume being produced and being communicated to at least a further second means for reverse osmosis or RO,
the permeate portion substantially passing through the at least further second RO means and being discharged at an environmental release point to the ambient environment or recycled to the plant for reuse, a small sub-reject portion of the permeate portion not passing through the at least further second RO means being recycled in front of said step (b).

3. The method of claim 2, wherein:
the biotreatment element being a carbon-media-microbioorganism column producing nitrogen gas distribution and having a strainer means, and being actively maintained continuously for use as needed, the biotreatment element being supplied by a nutrient means functionally connected to said point r for nutrient supply to said biotreatment element as needed for continuous around the clock functional availability thereof, for removing NX when present in the biotreatment liquid.

4. The method of claim 3, further comprising:
Step (d) transmitting said biotransformed liquid to the environmental release point for safe and timely discharge thereat.

5. A method, using a continuous retained biotreatment element, for treating a feed volume from a plant containing aqueous substances having organic nitrate explosive matter, or NX, therewithin, for removal thereof, and for use in at least one way of a group consisting of: discharge to the environment, recycle, and biotreatment, said method comprising:
(a) removing at least part of suspended solids, oils and greases, metal complexes and colloidal material in said volume; then
(b) treating the feed volume by a first reverse osmosis or RO means and sending a reject fluid portion of the feed volume, from a point q proximate but beyond the inflow side of said first RO means, to a chilling crystallization system, and sending a permeate portion of the feed volume to a second RO means,
the permeate portion substantially passing through the second RO means and thence to said discharge at to the environment by means of an environmental release point to the ambient environment or said recycle, being recycled to the plant for reuse, a small sub-reject portion of the permeate portion not passing through the second RO means being recycled in front of step (b);
said chilling crystallization system having at least first and second reject tanks each functionally linked to a chiller subassembly such that each reject tank in being chilled to a lower temperature, near, but above the freezing point of water, causes NX crystallization and precipitation materials to form from at least part of the contents within each such reject tank, each said reject tank having means for timely evacuation of the crystallization and precipitation materials;
(c) communicating a first sub-portion of the reject fluid to the first reject tank to form a first residence fluid, and a second sub-portion of the reject fluid to the second reject tank to form a second residence fluid, and during at least respective x and y-periods of time as to residence within the first reject tank and the second reject tank, carrying out at least the following sub-steps:
(1) transmitting a portion of the first residence fluid from the first reject tank to a bag filter means and from the bag filter means to at least one filter means chosen from a group of such means consisting of an SWRO filter means and a HPRO filter means, to form a reject first residence fluid and a permeate first residence fluid, the permeate first residence fluid being recycled to said point q, and the reject first residence fluid being communicated back to the first reject tank,
a biotreatment liquid being formed therewithin said second reject tank, and
(2) passing the biotreatment liquid through a bag filter means and from said bag filter means to a point r, and from the point r to the continuous retained biotreatment element or biotreatment element, for the production of a resulting biotransformed liquid, which will contain amounts of NX materials therewithin when the biotreatment liquid still comprises NX materials,
the biotreatment element being a carbon-media-microbioorganism column producing nitrogen gas distribution and having a retention means, and being actively maintained continuously for use as needed, the biotreatment element being supplied by a nutrient means functionally connected to said point r for nutrient supply to said biotreatment element as needed for continuous around the clock functional availability thereof, while maintaining the functional ability to remove NX materials when such materials are still present in the biotreatment liquid; and
(d) transmitting said resulting biotransformed liquid to the environmental release point for discharge thereat.

6. The method according to claim 1, wherein,
in step (a), further comprising communicating the feed volume to a sub-system having cross-flow membranes for filtering to about 0.05 micron.

7. The method according to claim 5, wherein,
in step (a), further comprising communicating the feed volume to a sub-system having cross-flow membranes for filtering to about 0.05 micron.

8. A method and system for treating aqueous substances or feed having organic nitrate explosive matter or NX therewithin, for marshaling and positioning the NX, said method comprising:
communicating the feed to a means for reverse osmosis or RO for removal of the NX, thereby bringing about a permeate volume passing through the RO, with little or no NX, which is then communicated for one of a group of activities consisting of at least one reuse or recycle activity and discharge, and a reject volume of the feed not passing through the RO.

9. The method in accordance with claim 8; wherein, the reject volume not passing through the RO being communicated to a means for NX crystallization, said means for NX crystallization being kept at a temperature which is above but near the freezing point of water such that little or no freezing of water present in the reject volume occurs.

10. The method in accordance with claim 9; wherein, after communicating to the means for NX crystallization, further comprising:
communicating the reject volume to a means for solid-liquid separation, and, thereafter,
to the marshaling and positioning of the NX for recovery thereof.

11. The method in accordance with claim 10, before the marshaling and positioning, further comprising communicating the reject volume to a means for continuous contained biotreatment for further removal of NX when present and use in one of a group of activities consisting of discharge to the environment and a least one activity involving recycle to the system.

12. The method in accordance with claim 11, wherein the means for continuous contained biotreatment having a carbon-media-microbioorganism column.
